(19) United States
(12) Patent Application Publication
(10) Pub. No.: US 2008/0099391 A1
(43) Pub. Date: May 1, 2008

(54) Magnetic device for treating water

(76) Inventor: Hsin Ho Lin, Taichung (TW)

Correspondence Address: CHARLES E. BAXLEY, ESQ., 90 JOHN STREET, THIRD FLOOR, NEW YORK, NY, 10038, US

(21) Appl. No.: 11/590,731

(22) Filed: Oct. 31, 2006

(51) Int. Cl. C02F 1/48

(52) U.S. Cl. 210/222; 204/557

(57) ABSTRACT

A magnetic treating device includes a water container, a hose coupled to the water container with a coupling device for supplying water into the water container, and a number of magnetic members engaged onto the hose for activating the water flowing through the hose. The coupling device includes a nut member and a threaded member for securing the hose. The nut member includes a pipe for receiving the hose and for forming an annular channel between the nut member and the pipe. An outer covering may be engaged onto the hose and the magnetic members, and an activating agent may be disposed between the outer covering and the magnetic members.

### BACKGROUND OF THE INVENTION

1. Field of the Invention

The present invention relates to a magnetic treating device, and more particularly to a magnetic treating device for readily attaching or coupling to a water container or a water reservoir and for treating the water flowing through the magnetic treating device and to the water container or the water reservoir without contacting with the water flowing into the water container or the water reservoir.

2. Description of the Prior Art

Typical water filters or water treating facilities may comprise one or more magnetic devices or members disposed or engaged into the water container or the water reservoir for magnetically treating the fluid or water that flows through the water filters or water treating facilities.

For example, U.S. Pat. No. 4,048,030 to Miller discloses one of the typical electrolytic cells for treatment of water and comprising a number of electrodes disposed in a container for being energized to release or to discharge aluminum ions or iron ions into the water passing through the cell.

However, the water passing through the cell may directly contact with the electrodes, and the electrodes may be rusted after use such that the water passing through the cell may have a good chance to be contaminated by the rusted electrodes.

U.S. Pat. No. 6,294,089 to Yeh discloses another typical water filter comprising one or more magnetic devices coupled between one or more filter devices, and the magnetic devices each include one or more magnetic members received in a tube for forming one or more water passages in the tube and for activating the water flowing through the tube.

However, similarly, the water passing through the tube may also directly contact with the magnetic members, and the magnetic members may also be rusted after use such that the water passing through the tube may also have a good chance to be contaminated by the rusted magnetic members.

The present invention has arisen to mitigate and/or obviate the afore-described disadvantages of the conventional magnetic devices for treating water.

### SUMMARY OF THE INVENTION

The primary objective of the present invention is to provide a magnetic treating device for readily attaching or coupling to a water container or a water reservoir and for treating the water flowing through the magnetic treating device and to the water container or the water reservoir without contacting with the water flowing into the water container or the water reservoir.

In accordance with one aspect of the invention, there is provided a magnetic treating device comprising a water container, a hose coupled to the water container for supplying water into the water container, and a number of magnetic members engaged onto the hose for activating the water flowing through the hose.

The water container includes an inlet mouth having an opening formed therein for coupling to the hose. The opening of the inlet mouth of the water container is a threaded opening, and the hose includes a coupling device secured to one end of the hose for coupling to the opening of the inlet mouth of the water container.

The coupling device includes a nut member having a bore formed therein, and having an inner thread formed therein, and a threaded member having a bore formed therein for receiving the hose, and having an outer thread formed thereon for engaging with the inner thread of the nut member and for securing the hose to the nut member.

The nut member includes a pipe provided in the bore of the nut member for receiving the hose, and for forming an annular channel between the nut member and the pipe. The nut member includes a peripheral flange coupled between the nut member and the pipe for retaining the pipe in the nut member and for forming an enclosed annular channel between the nut member and the pipe.

The pipe of the nut member includes an inclined outer peripheral surface formed thereon, and the threaded member includes an inclined inner peripheral surface formed therein for engaging with the inclined outer peripheral surface of the nut member and for forcing the pipe onto the hose and to secure the hose to the pipe of the nut member.

The threaded member includes a protruded driven member extended outwardly therefrom. A number of magnetically attractive members may further be provided and engaged onto the hose. The magnetically attractive members and the magnetic members are disposed and arranged alternatively for forming a flexible and cylindrical member and for reinforcing the hose.

The water container includes at least one retainer for engaging with and for supporting the hose. An outer covering may further be provided and engaged onto the hose and the magnetic members.

An activating agent may further be provided and disposed between the outer covering and the magnetic members. The activating agent includes a number of nanometer particles and/or a number of nanometer powders disposed between the outer covering and the magnetic members.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a magnetic treating device in accordance with the present invention;

FIG. 2 is another perspective view of the magnetic treating device, in which an outer covering or sheath has been removed for showing the inner structure of the magnetic treating device;

FIG. 3 is a partial exploded view of the magnetic treating device;

FIG. 4 is another partial exploded view of the magnetic treating device;

FIG. 5 is a further partial exploded view of the magnetic treating device; and

FIG. 6 is a plan schematic view illustrating the other arrangement of the magnetic treating device.

### DETAILED DESCRIPTION OF THE PREFERRED EMBODIMENT

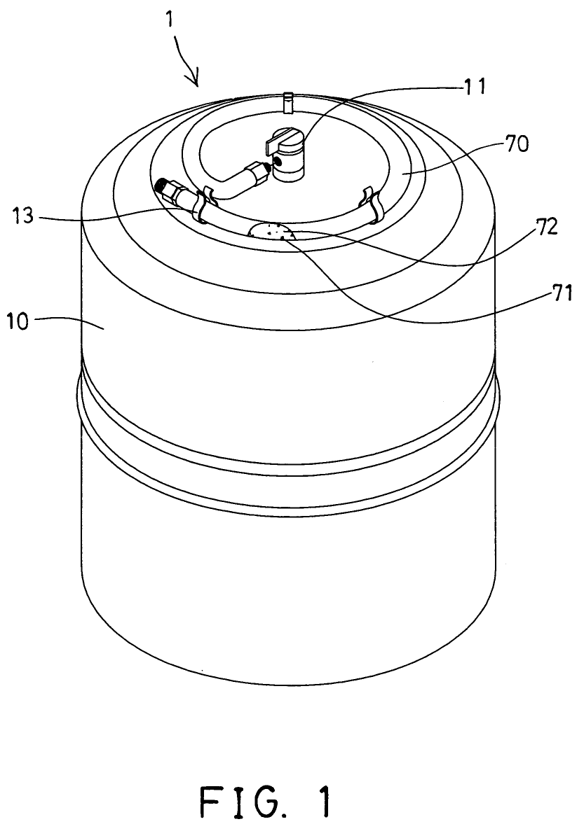

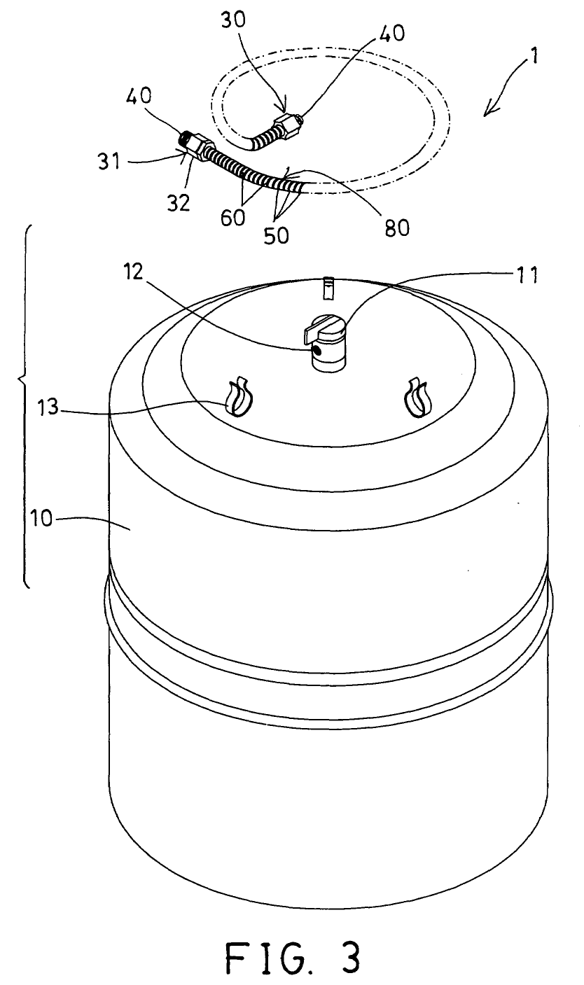

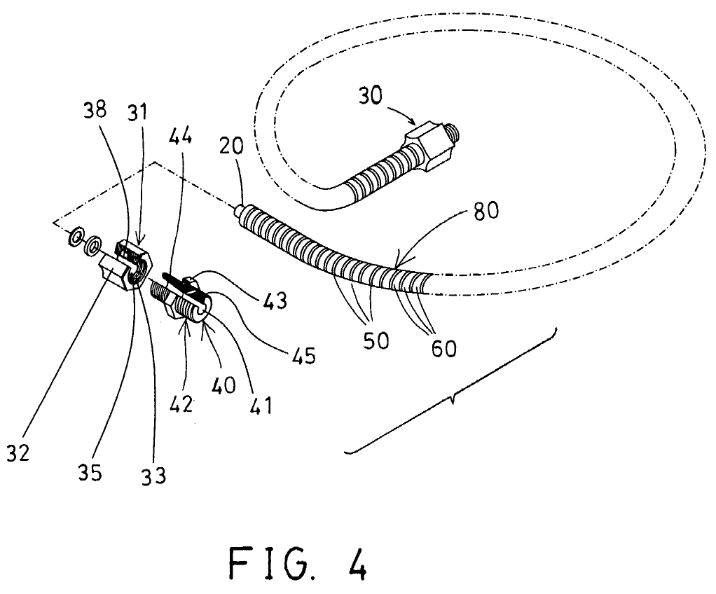

Referring to the drawings, and initially to FIGS. 1-3, a magnetic treating device 1 in accordance with the present invention comprises a water reservoir or a water container 10 which is typically coupled to a water treating or water filtering facility (not shown), such as a ultrafiltration film, a reverse osmosis film, or the like for receiving and storing the treated or filtered water. The water container 10 includes an inlet port or mouth 11 having an opening 12, such as a threaded opening 12 formed therein for coupling to a hose 20 (FIG. 4) which may be coupled to a water faucet or a water source (not shown) or to the water treating or water filtering facility for supplying the water into the water container 10.

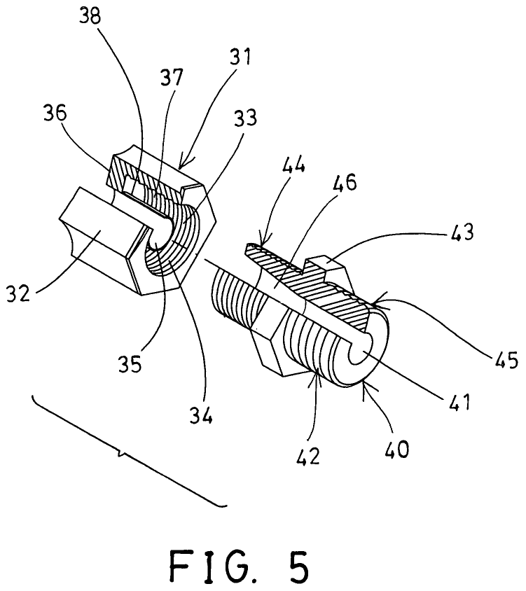

A fastener or coupling device 30 is attached or secured to one end of the hose 20 for coupling the hose 20 to the mouth 11 of the water container 10, and another fastener or coupling device 31 is attached or secured to the other end of the hose 20 for coupling the hose 20 to the water faucet or water source or to the water treating or water filtering facility. As best shown in FIGS. 4 and 5, the coupling devices 30, 31 each include an outer lock nut or nut member 32 having a bore 33 formed therein and having an inner thread 34 formed therein, and having a pipe 35 provided or extended in the bore 33 of the nut member 32, and having a peripheral flange 36 extended or formed or coupled between the nut member 32 and the pipe 35 for retaining the pipe 35 in the nut member 32 and for forming a blinded or enclosed peripheral or annular channel 37 between the nut member 32 and the pipe 35.

The coupling devices 30, 31 each further include an inner threaded shank or member 40 having a bore 41 formed therein for receiving or engaging one end of the hose 20, and having an outer thread 42 formed thereon for threading or engaging with the inner thread 34 of the nut member 32, and having a protruded driven member 43 extended outwardly from the middle portion of the threaded member 40 for separating the threaded member 40 into two threaded ends 44, 45, in which the threaded end 44 may be threaded or engaged with the inner thread 34 of the nut member 32, and may be engaged into the annular channel 37 that is formed between the nut member 32 and the pipe 35, for forcing the pipe 35 onto the hose 20 and for solidly securing the hose 20 to the pipe 35 of the nut member 32. The protruded driven member 43 allows the threaded member 40 to be rotated or driven by the driving tools or the like (not shown).

It is preferable that the pipe 35 of the nut member 32 includes a tapered or inclined outer peripheral surface 38 formed thereon, and the threaded member 40 includes a tapered or inclined inner peripheral surface 46 formed therein for engaging with the corresponding tapered or inclined outer peripheral surface 38 of the nut member 32, or for forming a wedge or frustum-shaped threaded end 44 and for engaging into the annular channel 37 that is formed between the nut member 32 and the pipe 35, the tapered or inclined inner peripheral surface 46 of the threaded member 40 may be engaged with the tapered or inclined outer peripheral surface 38 of the nut member 32 in order to force the pipe 35 onto the hose 20 and to further solidly secure the hose 20 to the pipe 35 of the nut member 32.

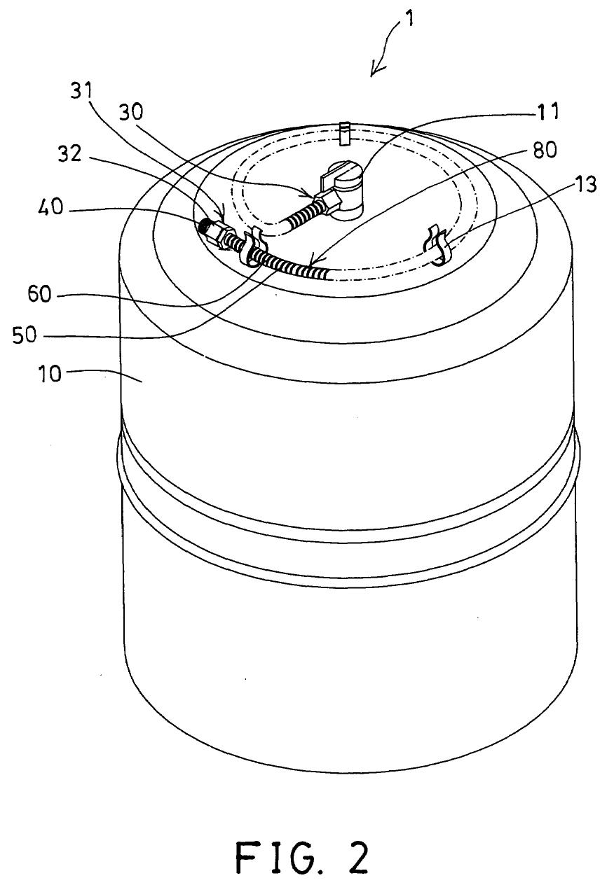

The other threaded end 45 of the threaded member 40 may be threaded or engaged with the threaded opening 12 of the mouth 11 of the water container 10 for coupling the hose 20 to the mouth 11 of the water container 10. The magnetic treating device 1 further includes a number of annular or ring-shaped magnetic members 50, such as magnets 50, and/or a number of annular or ring-shaped magnetically attractive members 60, such as iron or metal materials engaged onto the outer peripheral portion of the hose 20 and disposed or arranged alternatively (FIGS. 2-4) for forming a flexible and cylindrical member 80 and for reinforcing or protecting the hose 20. The magnetic members 50 and/or the magnetically attractive members 60 may treat or activate the water flowing through the hose 20.

The magnetic treating device 1 may further include an outer covering or sheath 70 engaged onto the outer peripheral portion of the hose 20 and the flexible and cylindrical member 80 that is formed by the magnetic members 50 and/or the magnetically attractive members 60, and an activating or catalyzing agent 71, 72 disposed between the outer covering or sheath 70 and the flexible and cylindrical member 80. The activating or catalyzing agent 71, 72 may include a number of nanometer particles 71 and/or a number of nanometer powders 72 for catalyzing the magnetic members 50 and/or the magnetically attractive members 60, and/or for facilitating or increasing the electric charge conductibility for the magnetic members 50 and/or the magnetically attractive members 60.

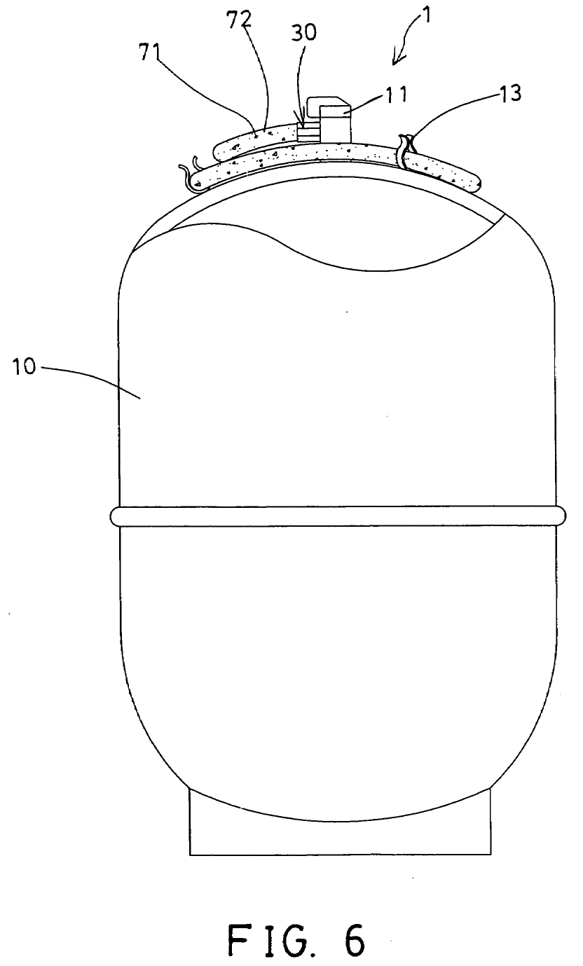

Alternatively, as shown in FIG. 6, without the outer covering or sheath 70, the activating or catalyzing agent 71, 72 may be directly applied or attached onto the outer peripheral portion of the flexible and cylindrical member 80. The hose 20 and the activating or catalyzing agent 71, 72 may be engaged and supported on the water container 10 with one or more hooks or retainers 13. As shown in FIG. 1, the outer covering or sheath 70 may also be supported on the water container 10 with one or more hooks or retainers 13. Alternatively, as shown in FIGS. 2-4, without the outer covering or sheath 70 and the activating or catalyzing agent 71, 72, the hose 20 and the flexible and cylindrical member 80 or the magnetic members 50 and/or the magnetically attractive members 60 may also be supported on the water container 10 with one or more hooks or retainers 13.

It is to be noted that the magnetic treating device 1 in accordance with the present invention may be easily and readily attached or coupled to the water container 10 and to the water faucet or water source or to the water treating or water filtering facility without changing the structure or the configuration of the water container 10 and the water treating or water filtering facility, and may easily and readily treat or activate or magnetize or catalyze the water flowing through the hose 20. The magnetic members 50 and/or the magnetically attractive members 60 will not be contacted with the water flowing through the hose 20 such that the water will not be contaminated by the magnetic members 50 and/or the magnetically attractive members 60. It is further to be noted that the magnetically attractive members 60 may be made of iron or metal materials that are cheaper than the magnets 50.

Accordingly, the magnetic treating device in accordance with the present invention may be provided for attaching or coupling to the water container or water reservoir and for treating the water flowing through the magnetic device and to the water container or the water reservoir without contacting with the water flowing into the water container or the water reservoir.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A magnetic treating device comprising:
a water container,
a hose coupled to said water container for supplying water into said water container, and
a plurality of magnetic members engaged onto said hose for activating the water flowing through said hose.

2. The magnetic treating device as claimed in claim 1, wherein said water container includes an inlet mouth having an opening formed therein for coupling to said hose.

3. The magnetic treating device as claimed in claim 2, wherein said opening of said inlet mouth of said water container is a threaded opening, and said hose includes a coupling device secured to one end of said hose for coupling to said opening of said inlet mouth of said water container.

4. The magnetic treating device as claimed in claim 3, wherein said coupling device includes a nut member having a bore formed therein, and having an inner thread formed therein, and a threaded member having a bore formed therein for receiving said hose, and having an outer thread formed thereon for engaging with said inner thread of said nut member and for securing said hose to said nut member.

5. The magnetic treating device as claimed in claim 4, wherein said nut member includes a pipe provided in said bore of said nut member for receiving said hose, and for forming an annular channel between said nut member and said pipe.

6. The magnetic treating device as claimed in claim 5, wherein said nut member includes a peripheral flange coupled between said nut member and said pipe for retaining said pipe in said nut member and for forming an enclosed annular channel between said nut member and said pipe.

7. The magnetic treating device as claimed in claim 5, wherein said pipe of said nut member includes an inclined outer peripheral surface formed thereon, and said threaded member includes an inclined inner peripheral surface formed therein for engaging with said inclined outer peripheral surface of said nut member and for forcing said pipe onto said hose and to secure said hose to said pipe of said nut member.

8. The magnetic treating device as claimed in claim 4, wherein said threaded member includes a protruded driven member extended outwardly therefrom.

9. The magnetic treating device as claimed in claim 1 further comprising a plurality of magnetically attractive members engaged onto said hose.

10. The magnetic treating device as claimed in claim 9, wherein said magnetically attractive members and said magnetic members are disposed and arranged alternatively for forming a flexible and cylindrical member and for reinforcing said hose.

11. The magnetic treating device as claimed in claim 1, wherein said water container includes at least one retainer for engaging with and for supporting said hose.

12. The magnetic treating device as claimed in claim 1 further comprising an outer covering engaged onto said hose and said magnetic members.

13. The magnetic treating device as claimed in claim 1 further comprising an activating agent disposed between said outer covering and said magnetic members.

14. The magnetic treating device as claimed in claim 13, wherein said activating agent includes a plurality of nanometer particles disposed between said outer covering and said magnetic members.

15. The magnetic treating device as claimed in claim 13, wherein said activating agent includes a plurality of nanometer powders disposed between said outer covering and said magnetic members.
